(19) United States
(12) Patent Application Publication
(10) Pub. No.: US 2017/0121150 A1
(43) Pub. Date: May 4, 2017

(54) ELEVATOR SYSTEM

(71) Applicants: Auréllen FAUCONNET, Isdes (FR); Nicolas FONTENEAU, Vitry Aux Loges (FR); OTIS ELEVATOR COMPANY, Farmington, CT (US)

(72) Inventors: Aurelien Fauconnet, Isdes (FR); Nicolas Fonteneau, Vitry Aux Loges (FR)

(21) Appl. No.: 15/317,521

(22) PCT Filed: Jun. 11, 2014
(86) PCT No.: PCT/IB2014/001213

§ 371 Date: Dec. 9, 2016

(51) Int. Cl. B66B 11/00; B66B 11/02; B66B 9/00

(52) U.S. Cl. CPC B66B 11/0045; B66B 9/00; B66B 11/0226; B66B 11/0246

(57) ABSTRACT

An elevator system is provided including a hoistway having a plurality of landings including a top landing and a bottom landing. An elevator car including a car floor and a car roof is configured to move within the hoistway between the plurality of landings. A counterweight is configured to move within the hoistway. At least one tension member couples the elevator car and the counterweight. A support member is mounted within the hoistway. The support member includes a deflector sheave configured to receive the at least one tension member and prevent direct contact between the tension member and the support member. A machine assembly is mounted to the support member. When the elevator car is parked at a desired landing, the machine assembly is accessible from an interior of the elevator car.

### BACKGROUND

Exemplary embodiments of the invention relate to an elevator system, and more particularly, to a machine assembly for moving an elevator car of an elevator system.

Elevators carry passengers, cargo, or both between different evels in a building for example. There are different mechanisms for moving an elevator car within a hoistway. Traction-based elevator systems utilize a roping arrangement for suspending the elevator car and moving the car as desired within the hoistway. Most traction based systems include a counterweight. Traditionally, traction based elevator systems include a machine room in which the elevator machine, drive, and control components are located. For example, a separate structural room is positioned at the top of the hoistway, such as on a roof of a building. The machine room provides access to the motor, brake, drive, and controller components for service and maintenance operations. A modern trend in elevator systems has been to eliminate the machine room and provide a machine roomless elevator system. Eliminating the machine room provides the advantage of reducing construction cost otherwise associated with providing a separate machine room.

In current machine roomless elevator systems, the machine assembly is generally located above the roof of the elevator car when the elevator is at the top landing of the hoistway, to maximize the space in the hoistway available for the counterweight. Consequently, to access the machine assembly, such as for inspection or to perform maintenance, a mechanic may either stand on top of the car or use a ladder extending through a panel of the roof of the elevator car. Elevator codes, particularly in Europe, are expected to require an increase in clearance at the top of the hoistway. There is therefore a need to reposition the machine assembly within the hoistway for access by a mechanic.

### SUMMARY OF THE INVENTION

According to an embodiment of the invention, an elevator system is provided including a hoistway having a plurality of landings including a top landing and a bottom landing. An elevator car including a car floor and a car roof is configured to move within the hoistway between the plurality of landings. A counterweight is configured to move within the hoistway. At least one tension member couples the elevator car and the counterweight. A support member is mounted within the hoistway. The support member includes a deflector sheave configured to receive the at least one tension member and prevent direct contact between the tension member and the support member. A machine assembly is mounted to the support member. When the elevator car is parked at a desired landing, the machine assembly is accessible from an interior of the elevator car.

In addition to one or more of the features described above, or as an alternative, in further embodiments the machine assembly is arranged between the car floor and the car roof when the elevator car is parked at the desired landing.

In addition to one or more of the features described above, or as an alternative, in further embodiments the machine assembly is arranged centrally between the car floor and the car roof when the elevator car is parked at the desired landing.

In addition to one or more of the features described above, or as an alternative, in further embodiments the desired landing is the top landing of the hoistway.

In addition to one or more of the features described above, or as an alternative, in further embodiments the desired landing is the bottom landing of the hoistway.

In addition to one or more of the features described above, or as an alternative, in further embodiments the interior of the elevator car includes a plurality of panels and at least one of the plurality of panels is movable between a closed position and an open position.

In addition to one or more of the features described above, or as an alternative, in further embodiments the machine assembly is accessible from the interior of the elevator car when the at least one movable panel is in the open position.

In addition to one or more of the features described above, or as an alternative, in further embodiments the at least one movable panel is pivotable between the closed position and the open position.

In addition to one or more of the features described above, or as an alternative, in further embodiments the at least one movable panel is removable.

In addition to one or more of the features described above, or as an alternative, in further embodiments the machine assembly is positioned between the elevator car and a wall of the hoistway.

In addition to one or more of the features described above, or as an alternative, in further embodiments the deflector sheave is integrated with a side of the support member adjacent the elevator car.

In addition to one or more of the features described above, or as an alternative, in further embodiments the deflector sheave is configured to engage a portion of the at least one tension member extending between the machine assembly and the elevator car.

### BRIEF DESCRIPTION OF THE DRAWINGS

The subject matter, which is regarded as the invention, is particularly pointed out and distinctly claimed at the conclusion of the specification. The foregoing and other features and advantages of the invention are apparent from the following detailed description, taken in conjunction with the accompanying drawings, in which:

FIG. 1 is a perspective view of an elevator system according to an embodiment of the invention;

FIG. 2 is a cross sectional view of a portion of the elevator system of FIG. 1 according to an embodiment of the invention;

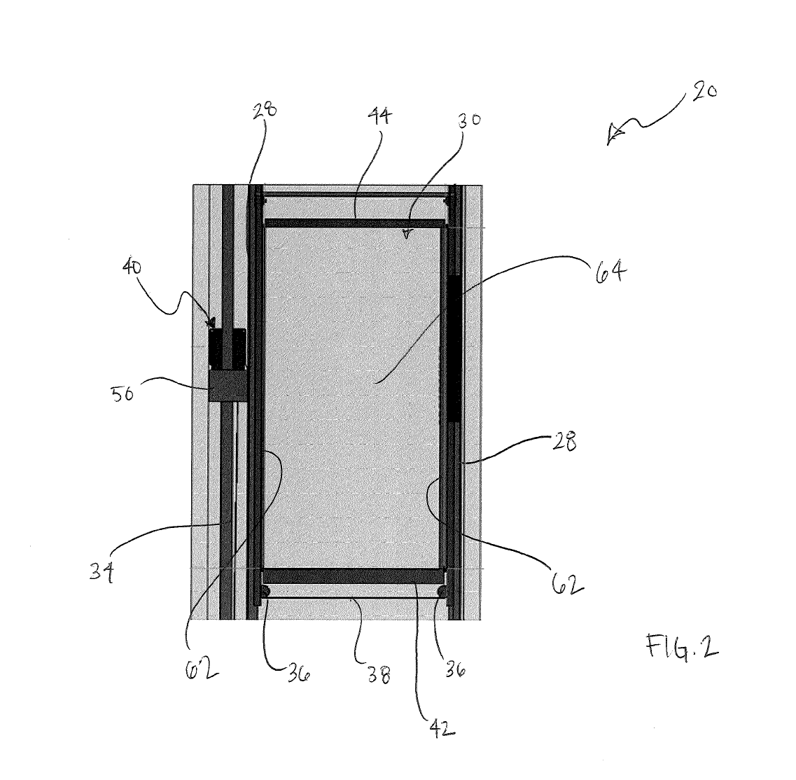

FIG. 3 is a top view of the elevator system of FIG. 1 according to an embodiment of the invention; and

FIG. 4 is a side view of the elevator system of FIG. 1, taken from the interior of the elevator car according to an embodiment of the invention.

The detailed description of the invention describes exemplary embodiments of the invention, together with some of the advantages and features thereof, by way of example with reference to the drawings.

### DETAILED DESCRIPTION OF THE INVENTION

Referring now to the FIGS., an elevator system 20 according to an exemplary embodiment of the present invention is illustrated. The elevator system 20 is located within a hoistway 22 having a plurality of landings (not shown) and extends generally from a floor 24 to a ceiling 26 of the hoistway 22. The hoistway 22 may extend over the entire height of a building, or alternatively, over only a portion of the height of a building. The elevator system 20 may be used in any type of elevator application, including low-rise, mid-rise, and high-rise applications. The elevator system 20 includes car guide rails 28 located on opposing sides of an elevator car 30 which guide the movement of the elevator car 30 within the hoistway 22. Guide assemblies (not shown) configured to maintain proper alignment of the elevator car 30 as it travels along the car guide rails 28 are disposed adjacent the top and bottom of the elevator car 30.

The elevator system 20 also includes a counterweight 32 configured to move vertically upwardly and downwardly within the hoistway 22. The counterweight 32 is configured to move in a direction opposite the movement of the elevator car 30 as is known in conventional elevator systems 20. Movement of the counterweight 32 is guided by counterweight guide rails 34 mounted within the hoistway 22.

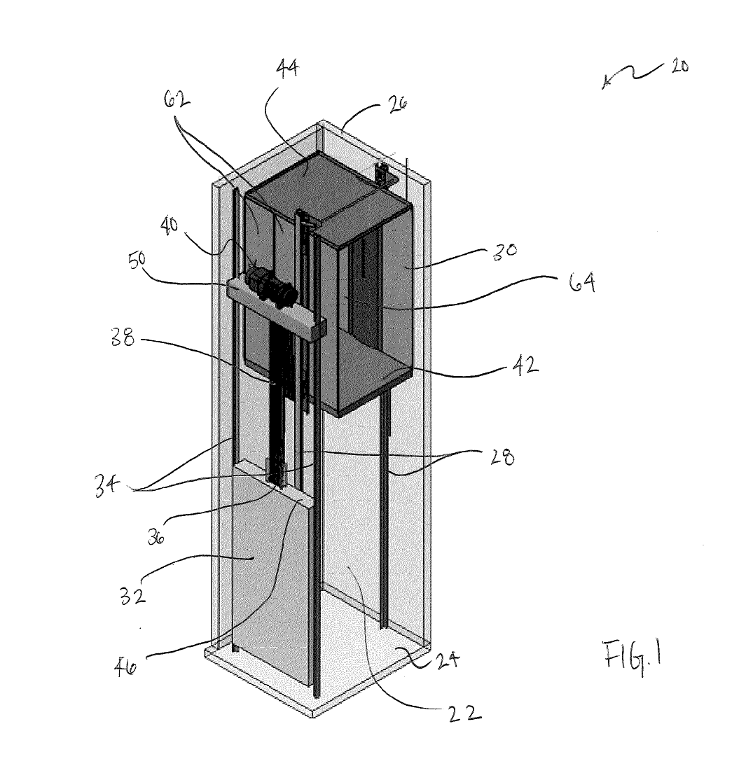

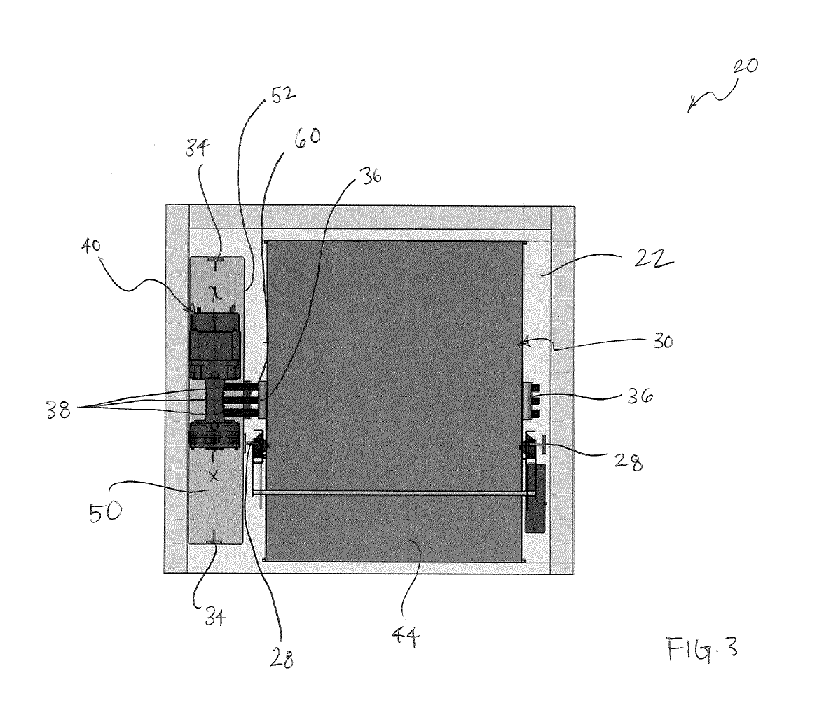

In the illustrated, non-limiting embodiment, the elevator car 30 and/or the counterweight 32 includes one or more deflector sheaves 36 configured to cooperate with at least one tension member 38 and a machine assembly 40 to raise and lower the elevator car 30 within the hoistway. The machine assembly 40 includes a traction sheave (not shown) having a plurality of grooves configured for use with a plurality of tension members 38. In the illustrated, non-limiting embodiment, the traction sheave in this exemplary embodiment of the invention is suited and sized for use with a plurality of flat, flexible belts; however systems 20 having other tension members 38, such as steel cables for example, are within the scope of the invention. The deflector sheaves 36 illustrated in FIGS. 1 and 3 are mounted to the bottom 42 of the elevator car 30 and to the top 46 of the counterweight 32. However, the deflector sheaves 36 may be mounted at another location on the elevator car 30 and counterweight 32, as recognized by a person having ordinary skill in the art.

The machine assembly 40 of the illustrated elevator system 20 is mounted atop of a support member 50, such as a bedplate for example, within the hoistway 22. As is known, opposed ends of the tension members 36 are terminated in the elevator system 20 at dead end hitches (not shown), such as integrally formed with the support member 50 for example. Although the elevator system 20 illustrated and described herein has an underslung 2:1 roping configuration, elevator systems 20 having other roping configurations and hoistway layouts are within the scope of the invention.

The support member 50 is mounted between the elevator car 30 and an adjacent wall of the hoistway 22, along the counterweight guide rails. The machine assembly 40 is accessible from the interior 52 of the elevator car 30 when the elevator car 30 is positioned at one of the landings in the hoistway 22. An axis of rotation X of the machine assembly 40 is substantially perpendicular to a plane defined by the elevator guide rails 28. In the illustrated, non-limiting embodiment, the machine assembly 40 is located centrally below the car roof 44 and above the car floor 42 when the elevator car 30 is parked at a landing, such as the landings located at the top 26 or bottom 24 of the hoistway 22.

As a result of the positioning of the machine assembly 40 within the hoistway 22, a bedplate deflector sheave 60 is integrated into a side 52 of the support member 50 closest to the elevator car 30. As illustrated, a portion of each of the tension members 38 of the system 20 extending between the machine assembly 40 and a nearby deflector sheave 36 of the car 30, contacts the bedplate deflector sheave 60. The deflector sheave 60 is configured to engage a portion of the tension members 38 extending between the machine assembly 40 and the elevator car 30. The deflector sheave 60 is intended to prevent interference between the one or more tension members 38 and an adjacent surface or edge of the support member 50.

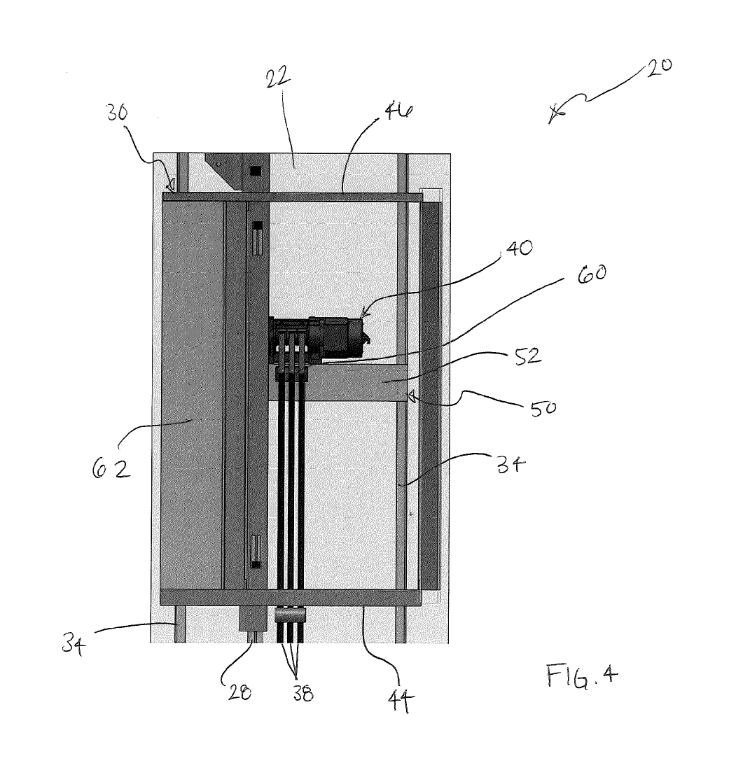

The elevator car 30 includes a plurality of similar or identical panels 62 (FIG. 1) aligned to define an interior 64 of the elevator car 30. As illustrated in FIG. 4, at least one of the plurality of panels 62 of the elevator car 30 is movable between a first, closed position (FIG. 1) and a second, open position. (FIG. 4). For example, the at least one movable panel 62 may be pivotable between the closed position and the open position, or alternatively, may be removable. When in the second position, the at least one panel 62 is configured to provide a mechanic positioned within the interior 64 of the elevator car 30 unobstructed, direct access to the adjacent machine assembly 40.

By positioning the machine assembly 40 near a landing within the hoistway 22, the elevator system 20 will comply with proposed changes to one or more elevator codes. Because the machine assembly 40 is directly accessible from the interior 64 of the elevator car 30, the safety and ease of performing inspection and maintenance operations is also significantly increased. In addition, the panel in the roof 46 of the elevator car 30 previously used to access the machine assembly 40 may be eliminated, thereby improving the aesthetic appeal of the interior 64 of the elevator car 30.

While the invention has been described in detail in connection with only a limited number of embodiments, it should be readily understood that the invention is not limited to such disclosed embodiments. Rather, the invention can be modified to incorporate any number of variations, alterations, substitutions, or equivalent arrangements not heretofore described but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. An elevator system, comprising:
a hoistway having a plurality of landings including a top landing and a bottom landing;
an elevator car configured to move within the hoistway between the plurality of landings, the elevator car including a car floor and a car roof;
a counterweight configured to move within the hoistway;
at least one tension member operably coupled to the elevator car and the counterweight;
a support member mounted within the hoistway, the support member including a deflector sheave configured to receive the at least one tension member and prevent the at least one tension member from directly contacting the support member; and
a machine assembly mounted to the support member, wherein when the elevator car is parked at a desired landing, the machine assembly is arranged between the car floor and the car roof and is accessible from an interior of the elevator car.

2. The elevator system according to claim 1, wherein when the elevator car is parked at the desired landing, the machine assembly is arranged between the car floor and the car roof.

3. The elevator system according to claim 1, wherein when the elevator car is parked at the desired landing, the machine assembly is arranged centrally between the car floor and the car roof.

4. The elevator system according to claim 1, wherein the desired landing is the top landing of the hoistway.

5. The elevator system according to claim 1, wherein the desired landing is the bottom landing of the hoistway.

6. The elevator system according to claim 1, wherein the interior of the elevator car includes a plurality of panels and at least one of the plurality of panels is movable between a closed position and an open position.

7. The elevator system according to claim 6, wherein the machine assembly is accessible from the interior of the elevator car when the at least one movable panel is in the open position.

8. The elevator system according to claim 6, wherein the at least one movable panel is pivotable between the closed position and the open position.

9. The elevator system according to claim 6, wherein the at least one movable panel is removable.

10. The elevator system according to claim 1, wherein the machine assembly is positioned between the elevator car and a wall of the hoistway.

11. The elevator system according to claim 10, wherein the deflector sheave is integrated with a side of the support member adjacent the elevator car.

12. The elevator system according to claim 11, wherein the deflector sheave is configured to engage a portion of the at least one tension member extending between the machine assembly and the elevator car.
